(19) United States
(12) Patent Application Publication
(10) Pub. No.: US 2026/0214363 A1
(43) Pub. Date: Jul. 23, 2026

(54) SPEAKER BOX

(71) Applicant: AAC Microtech (Changzhou) Co., Ltd., Changzhou City (CN)

(72) Inventors: Zhiwei Zhong, Changzhou (CN); Wei Song, Changzhou (CN); Xin Jin, Changzhou (CN)

(21) Appl. No.: 19/319,777

(22) Filed: Sep. 5, 2025

Related U.S. Application Data
(63) Continuation of application No. PCT/CN2025/074041, filed on Jan. 22, 2025.

(51) Int. Cl. H04R 1/02; H04R 7/04; H04R 9/02

(52) U.S. Cl. CPC H04R 1/02; H04R 7/04; H04R 9/025

(57) ABSTRACT

The present disclosure discloses a speaker box including a housing with an receiving space, a sound outlet penetrating the housing and communicating with the receiving space, and a sound generating unit accommodated in the receiving space and fixed to the housing; the sound generating unit partitioning the receiving space into a front cavity and a rear cavity, the front cavity communicating with the sound outlet; the sound generating unit further including a suspension elastic member; one side of the suspension elastic member being fixedly connected to a frame, and the other side being fixedly connected to a magnetic circuit system, such that the magnetic circuit system is suspended in the basket. The present disclosure mitigates and improving vibration perception when holding or contacting the speaker box, and improves high-frequency acoustic performance of the speaker box.

### CROSS REFERENCE TO RELATED APPLICATIONS

This application claims priority to PCT Patent Application No. PCT/CN2025/074041, entitled “SPEAKER BOX”, filed on January 22, 2025, which is incorporated by reference herein in its entirety.

### TECHNICAL FIELD

Various embodiments described in this document relate in general to the field of electroacoustic conversion, and more specifically to a speaker box.

### BACKGROUND

In recent years, with the rapid development of information technology, the penetration rate of audio devices continues to rise. People demand not only audio and video playback capabilities from these devices, but also increasingly require higher reliability, especially with the advent of the 5G era. Mobile multimedia technology has also developed accordingly. Many audio devices now integrate multiple entertainment functions, such as video playback, digital imaging, gaming, and GPS navigation. With the increasing demand for functionalities, the integration level of internal components continues to rise, and product quality requirements become increasingly stringent.

In audio devices, a speaker box is a commonly used electronic component, primarily used for audio signal playback, and its structural design directly affects audio playback quality. Common speaker boxes include a housing, a sound generating unit accommodated in the housing, and a front cavity and a rear cavity formed by cooperation between the sound generating unit and the housing. The sound generating unit includes a frame, a magnetic circuit system and a vibration system disposed in the frame, with the magnetic circuit system driving the vibration system to generate bass and treble. Common speaker boxes are often affected by the front cavity space, resulting in high-frequency resonance of the generated treble impacting the high-frequency acoustic performance of the speaker box. The frame and the entire device area connected to the frame are subjected to vibration effects from the vibration system, reducing user experience. Furthermore, prolonged vibration of the vibration system causes fatigue failure problems in electrical connections.

Therefore, it is desired to provide a new speaker box to solve the above technical issues.

### SUMMARY

In some embodiments, a speaker box includes a housing defining a receiving space, a sound outlet penetrating the housing and communicating with the receiving space, and a sound generating unit accommodated in the receiving space and fixed to the housing. The sound generating unit partitions the receiving space into a front cavity and a rear cavity, and the front cavity communicates with the sound outlet. The sound generating unit includes a frame fixed to the housing and defines an internal cavity, a vibration system fixed to a side of the frame close to the front cavity, a magnetic circuit system disposed in the internal cavity and configured to drive the vibration system to generate sound, and a suspension elastic member. The suspension elastic member connects to the frame and the magnetic circuit system, such that the magnetic circuit system is suspended in the internal cavity. The vibration system includes a first vibration subsystem, and a second vibration subsystem surrounding and spaced apart from the first vibration subsystem. The first vibration subsystem is coaxially arranged with the second vibration subsystem. The magnetic circuit system defines a first magnetic gap, and a second magnetic gap surrounding and spaced apart from the first magnetic gap. The first vibration subsystem includes a first diaphragm with a peripheral edge fixed to the magnetic circuit system, and a first voice coil configured to drive the first diaphragm to generate sound. The second vibration subsystem includes an annular second diaphragm, and a second voice coil configured to drive the second diaphragm to generate sound. The second diaphragm has an outer fixation portion fixed to the frame, and an inner fixation portion fixed to the magnetic circuit system. The first voice coil is inserted into the first magnetic gap and configured to drive the first diaphragm to generate high-frequency sound, and the second voice coil is inserted into the second magnetic gap and configured to drive the second diaphragm to generate low-frequency sound.

In some embodiments, the sound generating unit further includes an elastic gasket, and the elastic gasket is received in the front cavity. One side of the elastic gasket is fixed to the housing, and the other side of the elastic gasket is fixed to a side of the first diaphragm away from the magnetic circuit system. The elastic gasket and the first diaphragm are spaced apart to form a vibration gap.

In some embodiments, the sound generating unit further includes a first cover plate and a second cover plate. The first cover plate covers a side of the first diaphragm away from the magnetic circuit system, and the first cover plate is spaced apart from the first diaphragm. The second cover plate is fixed to the frame and covers a side of the magnetic circuit system away from the vibration system. One side of the elastic gasket is fixed to the housing, and the other side of the elastic gasket is fixed to a side of the first cover plate away from the first diaphragm.

In some embodiments, the magnetic circuit system includes a yoke, a first main magnetic part fixed to a side of the yoke close to the first diaphragm, an auxiliary magnetic part fixed to the yoke and surrounding an outer peripheral side of the first main magnetic part, an auxiliary pole core stacked and fixed to a side of the auxiliary magnetic part close to the first diaphragm, an annular first pole core stacked on a side of the first main magnetic part close to the first diaphragm, a second main magnetic part stacked and fixed to a side of the first pole core close to the first diaphragm, and a second pole core stacked and fixed to a side of the second main magnetic part close to the first diaphragm. A side of the auxiliary magnetic part away from the first main magnetic part is fixed to the suspension elastic member, the first main magnetic part and the auxiliary magnetic part are spaced apart to form the second magnetic gap, and the second main magnetic part and the first pole core cooperatively form the first magnetic gap.

In some embodiments, the magnetic circuit system further includes a fixation bracket, the fixation bracket circumferentially surrounds the second pole core, a peripheral edge of the first diaphragm is fixed to a top of the fixation bracket, and an inner fixation portion of the second diaphragm is sandwiched between a bottom of the fixation bracket and the second main magnetic part.

In some embodiments, the first pole core includes an annular pole core body stacked and fixed to the first main magnetic part, a pole core wall bent and extended from an inner peripheral side of the pole core body toward the first diaphragm, and a pole core top wall bent and extended inward from an inner peripheral side of the pole core wall. The second main magnetic part is stacked and fixed to a side of the pole core body close to the first diaphragm, and the second main magnetic part is spaced apart from the pole core wall and cooperatively forms the first magnetic gap.

In some embodiments, the magnetic circuit system further includes a magnetic circuit through hole penetrating the yoke, the first main magnetic part, and the first pole core. The sound generating unit further includes a conductive insert embedded in the magnetic circuit through hole and an elastic conductive member electrically connected to the conductive insert. The conductive insert includes a first conductive part fixed to a side of the first main magnetic part away from the first pole core, a second conductive part bent and extended from the first conductive part toward the first diaphragm and received in the magnetic circuit through hole, and a third conductive part bent and extended from the second conductive part. The third conductive part is fixed to a side of the pole core top wall close to the first diaphragm. The third conductive part is electrically connected to the first voice coil, and the elastic conductive member is electrically connected to the first conductive part.

In some embodiments, the elastic conductive member includes a connection portion electrically connected to the first conductive part and received in the magnetic circuit through hole, an extension portion extended outward from the connection portion and fixedly connected to a side of the yoke away from the first main magnetic part, an elastic portion bent and extended from the extension portion, and a rear cavity portion bent from the elastic portion toward the first diaphragm and extended to the rear cavity.

In some embodiments, the second vibration subsystem further includes a bobbin and a flexible printed circuit board. The bobbin is fixed to the second diaphragm, the bobbin connects the second voice coil and one end of the flexible printed circuit board, and another end of the flexible printed circuit board is fixed to the frame. The flexible printed circuit board is electrically connected to the second voice coil.

In some embodiments, the housing includes a first housing member and a second housing member mutually engaged to form the receiving space. The sound generating unit is fixed to an end of the first housing member close to the second housing member. The front cavity is enclosed by the first housing member and the sound generating unit cooperatively. The sound outlet penetrates the first housing, and the rear cavity is enclosed by the second housing member and the sound generating unit cooperatively.

### BRIEF DESCRIPTION OF THE DRAWINGS

The present embodiments are illustrated by way of example and not limitation in the figures of the accompanying drawings, in which like references may indicate similar elements.

FIG. 1 is a schematic diagram illustrating a perspective structure of a speaker box in accordance with some embodiments.

FIG. 2 is a schematic diagram illustrating a partial exploded view of the speaker box in accordance with some embodiments.

FIG. 3 is schematic diagram illustrating another partial exploded view of the speaker box in accordance with some embodiments.

FIG. 4 a cross-sectional view taken along line A-A of FIG. 1.

FIG. 5 a cross-sectional view taken along line B-B of FIG. 1.

### DETAILED DESCRIPTION OF THE EMBODIMENTS

The following will describe clearly and completely the technical solutions in the embodiments of the present disclosure in combination with the accompanying drawings. Obviously, the described embodiments are only a part of the embodiments of the present disclosure, not all of them. Based on the embodiments of the present disclosure, all other embodiments obtained by a person of ordinary skill in the art without making creative efforts shall fall within the scope of protection of the present disclosure.

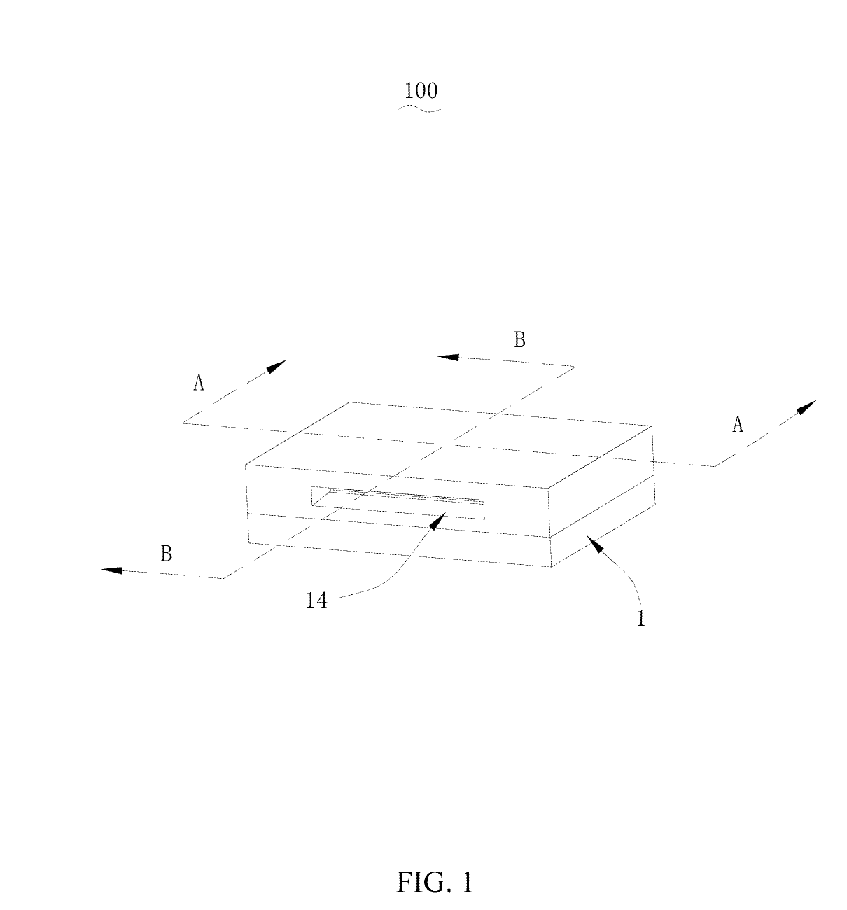

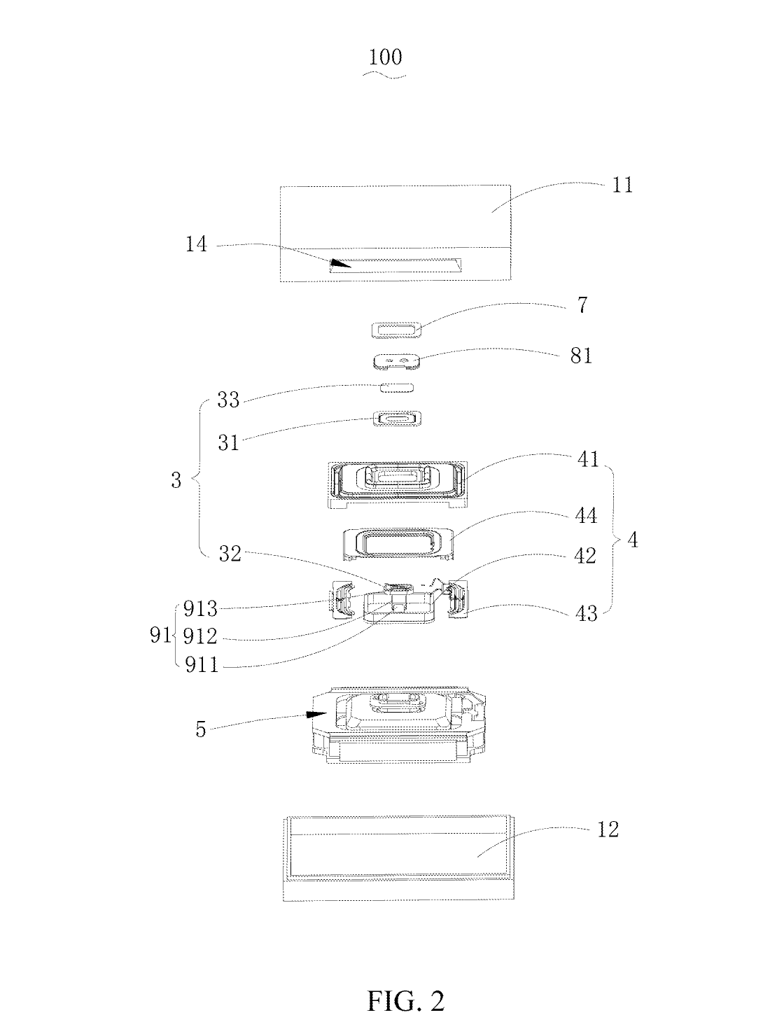

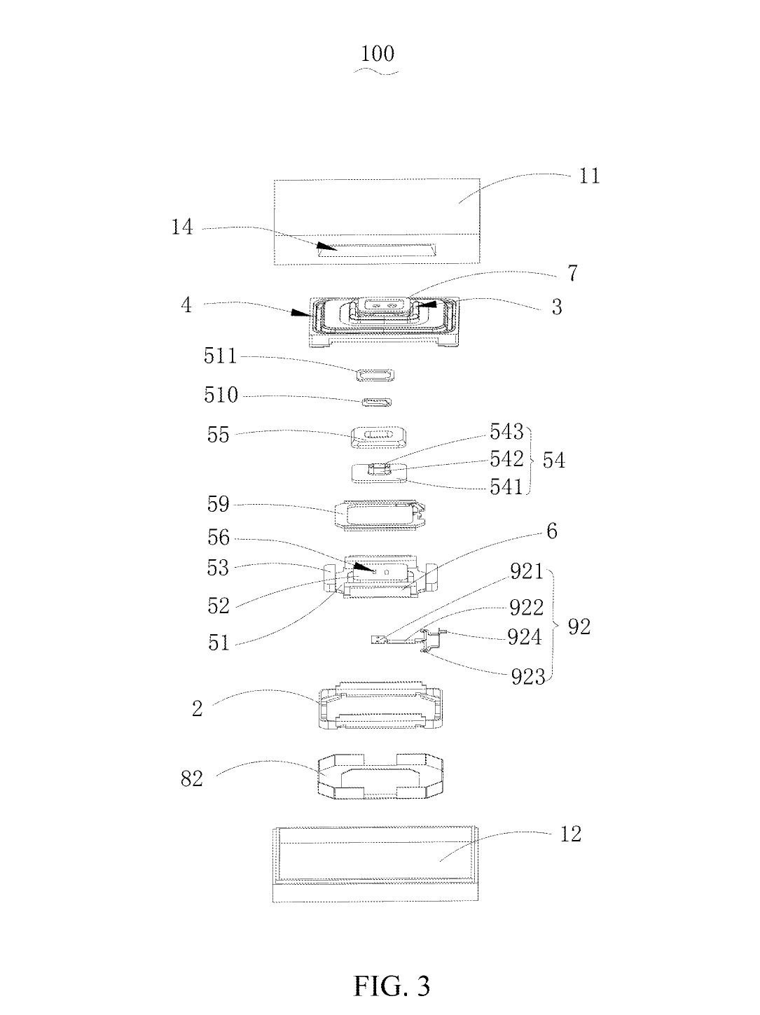

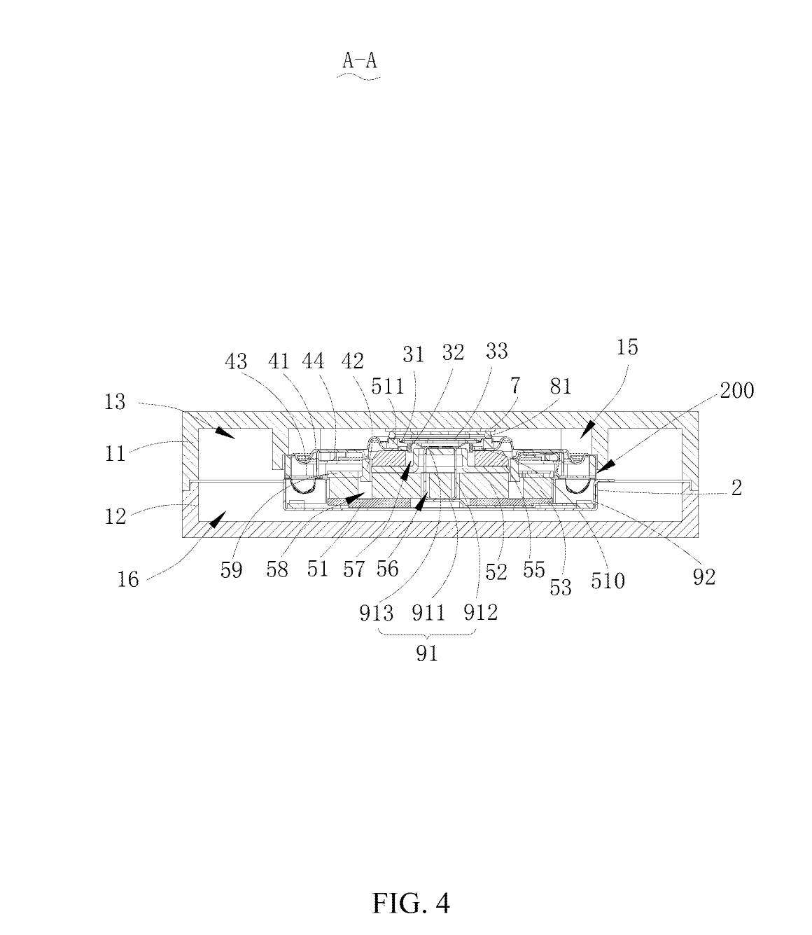

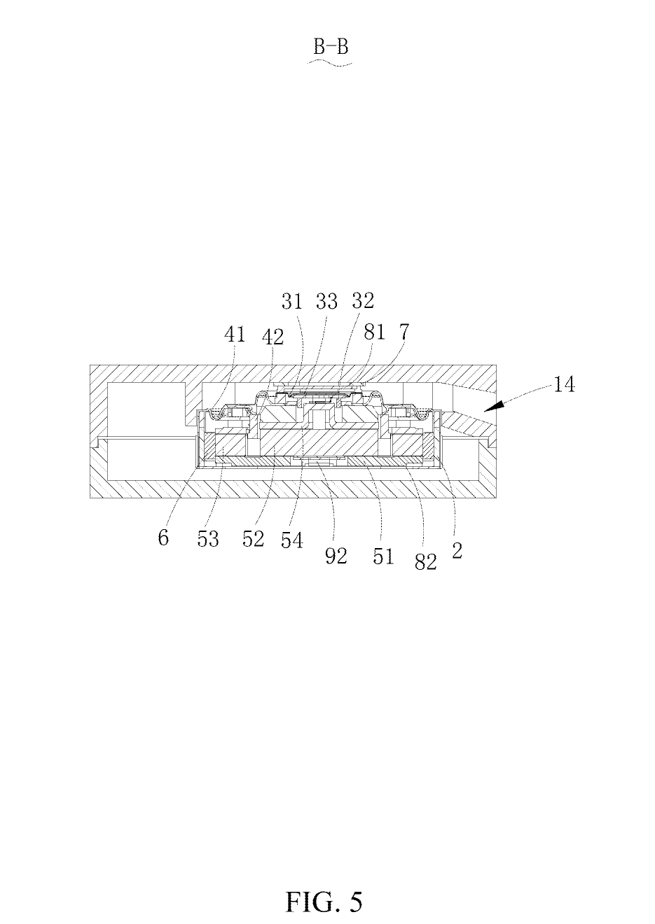

Referring to FIGS. 1 to 5, an embodiment of the present disclosure provides a speaker box 100. The speaker box 100 includes a housing 1 having a receiving space 13, a sound outlet 14 penetrating the housing 1 and communicating with the receiving space 13, and a sound generating unit 200 accommodated in the receiving space 13 and fixed to the housing 1. The sound generating unit 200 partitions the receiving space 13 into a front cavity 15 and a rear cavity 16, and the front cavity 15 communicates with the sound outlet 14.

The sound generating unit 200 includes a frame 2 fixed to the housing 1 and defining an internal cavity, a vibration system fixed to a side of the frame 2 close to the front cavity 15, a magnetic circuit system 5 disposed in the internal cavity and configured to drive the vibration system to generate sound, and a suspension elastic member 6.

In an exemplary embodiment, the housing 1 includes a first housing member 11 and a second housing member 12. The first housing member 11 and the second housing member 12 are mutually engaged to form the receiving space 13. The sound generating unit 200 is fixed to an end of the first housing member 11 close to the second housing member 12. The front cavity 15 is enclosed by the first housing member 11 and the sound generating unit 200 cooperatively. The sound outlet 14 is formed by penetrating through the first housing member 11. The rear cavity 16 is enclosed by the second housing member 12 and the sound generating unit 200 cooperatively.

The vibration system includes a first vibration subsystem 3, and a second vibration subsystem 4 surrounding and spaced apart from the first vibration subsystem 3. The first vibration subsystem 3 and the second vibration subsystem 4 are coaxially arranged. The magnetic circuit system 5 is provided with a first magnetic gap 57, and a second magnetic gap 58 surrounding and spaced apart from the first magnetic gap 57. The first vibration subsystem 3 includes a first diaphragm 31 with a peripheral edge fixed to the magnetic circuit system 5 and a first voice coil 32 driving the first diaphragm 31 to vibrate and generate sound. The second vibration subsystem 4 includes an annular second diaphragm 41, and a second voice coil 42 driving the second diaphragm 41 to vibrate and generate sound. An outer fixation portion of the second diaphragm 41 is fixed to the frame 2. An inner fixation portion of the second diaphragm 41 is fixed to the magnetic circuit system 5. The first voice coil 32 is inserted into the first magnetic gap 57 and drives the first diaphragm 31 to generate high-frequency sound. The second voice coil 42 is inserted into the second magnetic gap 58 and drives the second diaphragm 41 to generate low-frequency sound. It should be noted that a fixing manner in which the first diaphragm 31 and the second diaphragm 41 are fixed to the magnetic circuit system 5 includes, but is not limited to, being directly fixed to the magnetic circuit system 5 or being indirectly fixed to the magnetic circuit system 5 via a medium. As in the present embodiment, indirect fixing may be performed through a fixation bracket 511.

In an embodiment, the first vibration subsystem 3 further includes a dome 33 fixed to an inner peripheral side of the first diaphragm 31.

In an exemplary embodiment, the second vibration subsystem 4 further includes a flexible printed circuit board 43 and a bobbin 44. The bobbin 44 is fixed to the second diaphragm 42. The bobbin 44 is connected to the second voice coil 41 and one end of the flexible printed circuit board 43. The other end of the flexible printed circuit board 43 is fixed to the frame 2. The flexible printed circuit board 43 is electrically connected to the second voice coil 41.

In an exemplary embodiment, the magnetic circuit system 5 includes a yoke 51, a first main magnetic part 52 fixed to a side of the yoke 51 close to the first diaphragm 31, an auxiliary magnetic part 53 fixed to the yoke 51 and surrounding an outer peripheral side of the first main magnetic part 52, an annular first pole core 54 stacked on a side of the first main magnetic part 51 close to the first diaphragm 31, a second main magnetic part 55 stacked and fixed to a side of the first pole core 54 close to the first diaphragm 31, an auxiliary pole core 59 stacked and fixed to a side of the auxiliary magnetic part 53 close to the first diaphragm 31, a second pole core 510 stacked and fixed to a side of the second main magnetic part 55 close to the first diaphragm 31, and a fixation bracket 511.

The fixation bracket 511 circumferentially surrounds the second pole core 510. A peripheral edge of the first diaphragm 31 is fixed to a top of the fixation bracket 511, and an inner fixation portion of the second diaphragm 41 is sandwiched between a bottom of the fixation bracket 511 and the second main magnetic part 55. A side of the auxiliary magnetic part 53 away from the first main magnetic part 52 is fixed to the suspension elastic member 6. The first main magnetic part 52 and the auxiliary magnetic part 53 are spaced apart to form the second magnetic gap 58, and the second main magnetic part 55 and the first pole core 54 cooperatively form the first magnetic gap 57.

In an embodiment, the first pole core 54 includes an annular pole core body 541 stacked and fixed to the first main magnetic part 52, a pole core wall 542 bent and extended from an inner peripheral side of the pole core body 541 toward the first diaphragm 31, and a pole core top wall 543 bent and extended inward from an inner peripheral side of the pole core wall 542. The second main magnetic part 55 is stacked and fixed to a side of the pole core body 541 close to the first diaphragm 31. The second main magnetic part 55 is spaced apart from the pole core wall 542 and cooperatively forms the first magnetic gap 57.

In an exemplary embodiment, the magnetic circuit system 5 further includes a magnetic circuit through hole 56 penetrating the yoke 51, the first main magnetic part 52, and the first pole core 54.

The sound generating unit 200 further includes a suspension elastic member 6. The suspension elastic member 6 connects to the frame 2 and the magnetic circuit system 5, such that the magnetic circuit system 5 is suspended in the internal cavity of the frame 2. A side of the auxiliary magnetic part away from the first main magnetic part 52 is fixed to the suspension elastic member 6, and there are two suspension elastic members 6. The two suspension elastic members 6 are arranged at opposite sides of the magnetic circuit system 5, respectively. Of course, the quantity of the suspension elastic members 6 may be set according to actual conditions. Any number of suspension elastic members 6 arranged at intervals is feasible. The suspension elastic member 6 may be made of any elastic material, such as silicone rubber, foamed elastic material, etc. are feasible. Simultaneously, structural shape of the suspension elastic members 6 may also be set according to actual conditions, such as block-shaped, arc-shaped, bent-shaped, etc. are feasible. By the suspension elastic member 6 suspending the magnetic circuit system 5 in the frame 2, the reverse vibration of the magnetic circuit system 5 counteracts the vibration of the second vibration subsystem 4, ultimately reducing the vibration perception in the frame 2 and a component region connected to the frame 2, reducing and improving the vibration sensation due to holding or contacting the speaker box 100, and enhancing user experience.

In an exemplary embodiment, the sound generating unit 200 further includes an elastic gasket 7. The elastic gasket 7 is received the front cavity 15. One side of the elastic gasket 7 is fixed to the housing 1, and the other side of the elastic gasket 7 is fixed to a side of the first diaphragm 31 away from the magnetic circuit system 5. The elastic gasket 7 and the first diaphragm 31 are spaced apart to form a vibration gap. The elastic gasket 7 may be made of any elastic material, such as silicone rubber, foamed elastomer, etc., all being feasible. Meanwhile, a structure of the elastic gasket 7 may also be set based on actual conditions, such as block-shaped, annular, etc., all being feasible. By filling a space of the front cavity 15 with the elastic gasket 7, high-frequency resonance of a high-pitched sound generated by the first vibration subsystem 3 in the front cavity 15 is counteracted, and high-frequency acoustic performance of the speaker box 100 is improved.

In an embodiment, the sound generating unit 200 further includes a first cover plate 81 and a second cover plate 82. The first cover plate 81 covers a side of the first diaphragm 31 away from the magnetic circuit system 5, and the first cover plate 81 is spaced apart from the first diaphragm 31. The second cover plate 82 is fixed to the frame 2 and covers a side of the magnetic circuit system 5 away from the vibration system. One side of the elastic gasket 7 is fixed to the housing 1, and the other side of the elastic gasket 7 is fixed to a side of the first cover plate 81 away from the first diaphragm 31.

In an exemplary embodiment, the sound generating unit 200 further includes a conductive insert 91 embedded in the magnetic circuit through hole 56, and an elastic conductive member 92 electrically connected to the conductive insert 91. The conductive insert 91 includes a first conductive part 911 fixed to a side of the first main magnetic part 52 away from the first pole core 54, a second conductive part 912 bent and extended from the first conductive part 911 toward the first diaphragm 31 and received in the magnetic circuit through hole 56, and a third conductive part 913 bent and extended from the second conductive part 912. The third conductive part 913 is fixed to a side of the pole core top wall 543 close to the first diaphragm 31, the third conductive part 913 is electrically connected to the first voice coil 32, and the elastic conductive member 92 is electrically connected to the first conductive part 911.

In an embodiment, the elastic conductive member 92 includes a connection portion 921 electrically connected to the conductive insert 91 and received in the magnetic through-hole 56, an extension portion 922 extended outward from the connection portion 921 and fixedly connected to a side of the yoke 51 away from the first main magnetic portion 52, an elastic portion 923 bent and extended from the extension portion 922, and a rear cavity portion 924 bent from the elastic portion 923 toward the first diaphragm 31 and extended to the rear cavity 16. Any electrical connection design for the elastic conductive member 92 is feasible, such as FPC (Flexible Printed Circuit), conductive bent wires, etched or bent metal sheets, etc.. Through the elastic conductive member 92, electrical connection with the first vibration subsystem 3 can be achieved while reducing the overall stiffness of the magnetic circuit system 5, effectively preventing the problem of fatigue failure of the electrical connection due to vibration.

The present disclosure has several advantages over conventional speaker boxes. For example, the speaker box of the present disclosure suspends the magnetic circuit system in the frame via the suspension elastic member, thereby canceling the reverse vibration of the magnetic circuit system with the vibration of the second vibration subsystem, ultimately reducing the vibration perception on the frame and parts connected to the frame region, mitigating and improving the vibration sensation caused by holding or contacting the speaker box, and enhancing user experience. By filling the front cavity space with an elastic gasket, the high-frequency resonance of the treble in the front cavity is counteracted, improving the high-frequency acoustic performance of the speaker box. Via the elastic connector, electrical connection to the first vibration subsystem is achieved while reducing the overall stiffness of the magnetic circuit system, effectively preventing the problem of fatigue failure of the electrical connection due to vibration.

It will be understood that, although the terms first, second, etc., are, in some instances, used herein to describe various elements, these elements should not be limited by these terms. These terms are only used to distinguish one element from another. For example, a first vibration subsystem could be termed a second vibration subsystem, and, similarly, a second vibration subsystem could be termed a first vibration subsystem, without departing from the scope of the various described embodiments. The first widget and the second widget are both widget, but they are not the same condition unless explicitly stated as such.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A speaker box, comprising a housing defining a receiving space, a sound outlet penetrating the housing and communicating with the receiving space, and a sound generating unit accommodated in the receiving space and fixed to the housing, the sound generating unit partitioning the receiving space into a front cavity and a rear cavity, the front cavity communicating with the sound outlet, wherein
the sound generating unit comprises a frame fixed to the housing and defining an internal cavity, a vibration system fixed to a side of the frame close to the front cavity, a magnetic circuit system disposed in the internal cavity and configured to drive the vibration system to generate sound, and a suspension elastic member, the suspension elastic member connects to the frame and the magnetic circuit system, such that the magnetic circuit system is suspended in the internal cavity;
the vibration system comprises a first vibration subsystem, and a second vibration subsystem surrounding and spaced apart from the first vibration subsystem; the first vibration subsystem is coaxially arranged with the second vibration subsystem; the magnetic circuit system defines a first magnetic gap and a second magnetic gap surrounding and spaced apart from the first magnetic gap; the first vibration subsystem comprises a first diaphragm with a peripheral edge fixed to the magnetic circuit system, and a first voice coil configured to drive the first diaphragm to generate sound; the second vibration subsystem comprises an annular second diaphragm, and a second voice coil configured to drive the second diaphragm to generate sound; the second diaphragm having an outer fixation portion fixed to the frame, and an inner fixation portion fixed to the magnetic circuit system; the first voice coil is inserted into the first magnetic gap and configured to drive the first diaphragm to generate high-frequency sound; and the second voice coil is inserted into the second magnetic gap and configured to drive the second diaphragm to generate low-frequency sound.

2. The speaker box according to claim 1, wherein the sound generating unit further comprises an elastic gasket, the elastic gasket is received in the front cavity, one side of the elastic gasket is fixed to the housing and the other side of the elastic gasket is fixed to a side of the first diaphragm away from the magnetic circuit system, and the elastic gasket and the first diaphragm are spaced apart to form a vibration gap.

3. The speaker box according to claim 2, wherein the sound generating unit further comprises a first cover plate and a second cover plate, the first cover plate covers a side of the first diaphragm away from the magnetic circuit system and the first cover plate is spaced apart from the first diaphragm, the second cover plate is fixed to the frame and covers a side of the magnetic circuit system away from the vibration system, one side of the elastic gasket is fixed to the housing, and the other side of the elastic gasket is fixed to a side of the first cover plate away from the first diaphragm.

4. The speaker box according to claim 1, wherein the magnetic circuit system comprises a yoke, a first main magnetic part fixed to a side of the yoke close to the first diaphragm, an auxiliary magnetic part fixed to the yoke and surrounding an outer peripheral side of the first main magnetic part, an auxiliary pole core stacked and fixed to a side of the auxiliary magnetic part close to the first diaphragm, an annular first pole core stacked on a side of the first main magnetic part close to the first diaphragm, a second main magnetic part stacked and fixed to a side of the first pole core close to the first diaphragm, and a second pole core stacked and fixed to a side of the second main magnetic part close to the first diaphragm; a side of the auxiliary magnetic part away from the first main magnetic part is fixed to the suspension elastic member, the first main magnetic part and the auxiliary magnetic part are spaced apart to form the second magnetic gap, and the second main magnetic part and the first pole core cooperatively form the first magnetic gap.

5. The speaker box according to claim 4, wherein the magnetic circuit system further comprises a fixation bracket, the fixation bracket circumferentially surrounds the second pole core, a peripheral edge of the first diaphragm is fixed to a top of the fixation bracket; and an inner fixation portion of the second diaphragm is sandwiched between a bottom of the fixation bracket and the second main magnetic part.

6. The speaker box according to claim 4, wherein the first pole core comprises an annular pole core body stacked and fixed to the first main magnetic part, a pole core wall bent and extended from an inner peripheral side of the pole core body toward the first diaphragm, and a pole core top wall bent and extended inward from an inner peripheral side of the pole core wall, the second main magnetic part is stacked and fixed to a side of the pole core body close to the first diaphragm; and the second main magnetic part is spaced apart from the pole core wall and cooperatively forms the first magnetic gap.

7. The speaker box according to claim 6, wherein the magnetic circuit system further comprises a magnetic circuit through hole penetrating the yoke, the first main magnetic part, and the first pole core, the sound generating unit further comprises a conductive insert embedded in the magnetic circuit through hole and an elastic conductive member electrically connected to the conductive insert, the conductive insert comprises a first conductive part fixed to a side of the first main magnetic part away from the first pole core, a second conductive part bent and extended from the first conductive part toward the first diaphragm and received in the magnetic circuit through hole, and a third conductive part bent and extended from the second conductive part, the third conductive part being fixed to a side of the pole core top wall close to the first diaphragm; the third conductive part is electrically connected to the first voice coil; and the elastic conductive member is electrically connected to the first conductive part.

8. The speaker box according to claim 7, wherein the elastic conductive member comprises a connection portion electrically connected to the first conductive part and received in the magnetic circuit through hole, an extension portion extended outward from the connection portion and fixedly connected to a side of the yoke away from the first main magnetic part, an elastic portion bent and extended from the extension portion, and a rear cavity portion bent from the elastic portion toward the first diaphragm and extended to the rear cavity.

9. The speaker box according to claim 1, wherein the second vibration subsystem further comprises a bobbin and a flexible printed circuit board, the bobbin is fixed to the second diaphragm, the bobbin connects the second voice coil and one end of the flexible printed circuit board; another end of the flexible printed circuit board is fixed to the frame; and the flexible printed circuit board is electrically connected to the second voice coil.

10. The speaker box according to claim 1, wherein the housing comprises a first housing member and a second housing member mutually engaged to form the receiving space, the sound generating unit is fixed to an end of the first housing member close to the second housing member, the front cavity is enclosed by the first housing member and the sound generating unit cooperatively, the sound outlet penetrates the first housing; and the rear cavity is enclosed by the second housing member and the sound generating unit cooperatively.
